(19) United States
(12) Patent Application Publication
(10) Pub. No.: US 2024/0338663 A1
(43) Pub. Date: Oct. 10, 2024

(54) Digital Presence Information System

(71) Applicant: Sitekee Pty Ltd., Malvern (AU)

(72) Inventors: Mario Sultana, Malvern (AU); Ross Spearritt, Malvern (AU)

(73) Assignee: Sitekee Pty Ltd., Malvern, VI (AU)

(21) Appl. No.: 18/131,061

(22) Filed: Apr. 5, 2023

(51) Int. Cl. G06Q 10/20; H04W 4/021; H04W 4/029

(52) U.S. Cl. CPC G06Q 10/20; H04W 4/021; H04W 4/029

(57) ABSTRACT

A digital presence information system is network based software accessible from any suitable mobile device that will communicate with a status/check-in station on any suitable site or location that will exchange information with a status/check-in station on any suitable site, or on an asset, or the location of a specific task such as a hotel room or a patient's house. The user accessing the status/check-in station with a mobile device will be provided with safety or access updates for the suitable site, the status of the asset as well as any needed maintenance, provide access notice to a supervisor for a public or private site.

### FIELD OF THE INVENTIONS

The inventions described below relate to the field of digital presence information systems.

### BACKGROUND OF THE INVENTIONS

Many public access locations may be hazardous at various times and consequently, access to such sites is controlled to limit injuries and the liability of the site controller such as the state or business. It is expensive to have someone on site constantly to inform visitors of changing safety situations.

Distributed assets and equipment from elevators and forklifts to copy machines, computers, fire extinguishers and smoke detectors require periodic checks and maintenance. Keeping track of all the assets and performing the checks and required maintenance may be an extensive job if there are many assets and may be a forgotten job if there are only a few assets.

Similarly, in-person tasks such as housekeeping at hotels and the like, as well as home health care or other regular tasks require communication and monitoring to insure that the tasks are performed properly and to enable customized services to distinguish from competitors in the marketplace.

### SUMMARY

The devices and methods described below provide for a network based software system accessible from any suitable mobile device that will exchange information with a status/check-in station on any suitable site, or on an asset, or the location of a specific task such as a hotel room or a patient's house. The user accessing the status/check-in station with a mobile device will be provided with safety or access updates for the suitable site or the status of the asset as well as any needed maintenance and the system will provide an access notice to a supervisor for a public or private site.

For example, the exchanged information can include asset service information that is only captured when the user is very close to the asset. The digital presence information system ensures that serviceable assets are correctly maintained and documented in real time, including the ability to see asset service history, special service instructions and time lapse photos of the asset over time.

Multiple assets can be grouped together to ensure that no individual item is missed during a group asset service cycle. The digital presence information system contains high level security algorithms ensuring only authorized personal can record the asset service history. The system may also manage end of asset life cycle, servicing schedules and ensures assets are serviced at the correct intervals.

When an authorized service person interacts with a status/check-in station using a mobile device, the system automatically prompts the user to confirm the asset has been correctly serviced and is working correctly. The user can also document this service using a photo.

A status/check-in station may be embodied in any suitable form factor and may be placed near or on any physical asset such as a fire extinguisher, smoke detector, tool tags etc. Status/check-in stations may have adhesive backs for attaching them to an asset or location and they may enable tap to activate technology or any other suitable interaction technology. Status/check-in stations may also be placed in any location such as a cleaning cupboard, hotel room, or residence. When interacted with, the status/check-in station automatically records the user's presence at this location and specific service information is shown in real time.

A status/check-in station may also be used to ensure personnal have arrived at a location and this arrival and departure information is transmitted in real-time to authorized parties. Status/check-in stations may also be used to provide real time safety updates to the public for any location containing a status/check-in station. For example, a status/check-in station could be placed at a walking trail entrance and supply real time safety information about potential hazards in the area.

For example a status/check-in station may be placed in a hotel Room and whenever the room is cleaned, the cleaner taps the station at the start and end of the clean. Any custom cleaning information regarding this particular room is immediately shown to the cleaner. For example, a guest has requested non allergenic pillows and the status/check-in station will require the cleaner to confirm these pillows have been supplied.

A status/check-in station may be placed on every smoke detector in a public building and the building manager assigns the stations to one of many groups, e.g., Floor 1, Building 2, Old Style Smoke Detector etc. When the stations are interacted with, the user is requested to confirm they have tested the smoke detector and it is operating correctly. At any time, the building manager can check the service history of each icon/group and identify all smoke detectors that are overdue for a test/service.

A status/check-in station may be placed inside a residence and whenever a care provider arrives, they interact with the station using a mobile device to indicate their presence. Any issues regarding the client are displayed to the care provider and next of kin are informed that the care provider is now inside the residence. When the care provider leaves they interact with the station again and this departure information is then sent to all authorized parties.

A status/check-in station may also placed at the entrance to a national parks swimming hole and when tapped with a mobile device or otherwise interacted with, the mobile device displays real time information regarding the safely of the swimming hole. This information can be updated at any time from any location to reflect current conditions. Interaction with a status/check-in station requires that the mobile device touch, tap or be within 2-3 centimeters of the status/check-in station.

A status/check-in station may also be used as a trigger to pay for parking. Individual status/check-in stations are placed near each parking slot. A user pays for parking by tapping the status/check-in station related to their specific parking position, selects the parking time period from the list shown and payment is automatically taken within the App. Once the period has expired, the user can be prompted to extend the period. Parking enforcement can tap each status/check-in station to confirm that each parking slot is up to date.

A pet focused status/check-in station allows for lost pet locations to be instantly shared with the registered pet owner. A status/check-in tag is placed on the pet collar and the owner configures the tag using the related app. When a person finds the lost pet, they tap their mobile phone against this status/check-in tag which triggers a notification to the registered pet owner. This notification includes the current location of the pet and the phone details of the pet rescuer.

### BRIEF DESCRIPTION OF THE DRAWINGS

FIG. 1 is a block diagram illustration of the digital presence information system.

FIG. 2 is a flow chart for asset or location maintenance using the digital presence information system illustrated in FIG. 1.

FIG. 3 is a flow chart for location access using the digital presence information system illustrated in FIG. 1.

### DETAILED DESCRIPTION OF THE INVENTIONS

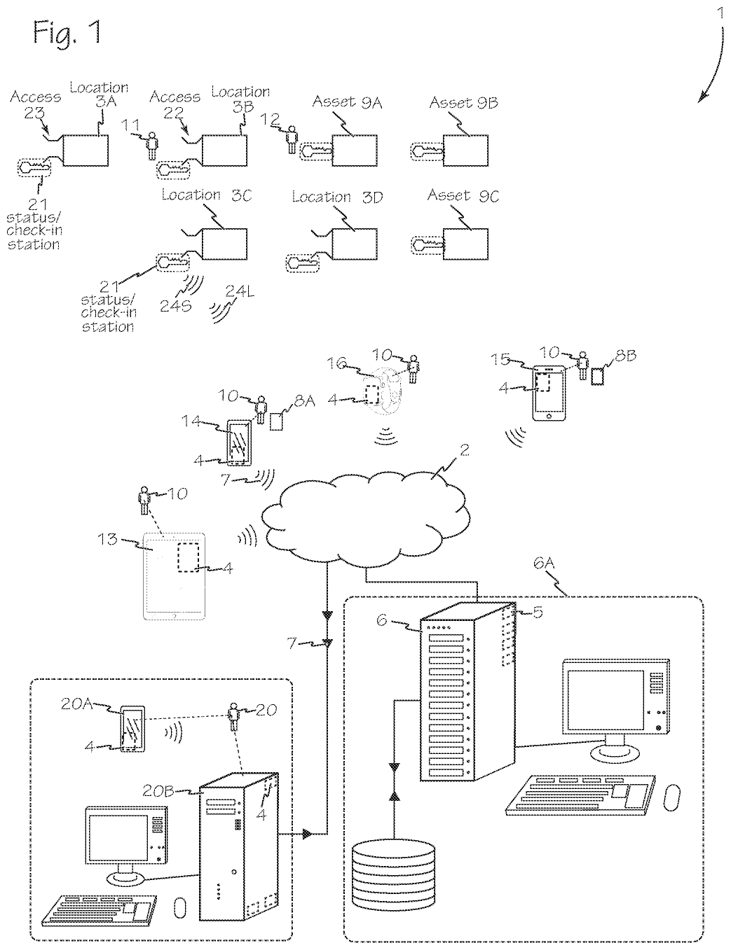

FIG. 1 is an illustration of digital presence information system 1 implements information and access control for asset or location maintenance and location access via network 2 which may be any suitable network such as a virtual private network, a mesh network or the world wide web covering locations 3A, 3B, 3C or 3D and assets such as assets 9A, 9B or 9C. System 1 may be implemented using any suitable software such as app 4 configured to operate on any suitable mobile device or computer and a central control location 6A with server software 5 operating on server 6. A user such as users 10, 11 and 12 seeking access to a location such as location 3A or to work at a location such as locations 3B, 3C or 3D or maintain an asset such as assets 9A, 9B or 9C may interact the digital presence information system status/check-in station 21, for site access, history control and notification app 4, using any suitable mobile device such as iPad or tablet 13, smart phones 14 and 15 and/or smart wearable 16 to provide digital documentation 7 to the location manager 20. Digital documentation 7 is any suitable digital representation of a required confirmation such a license 8A, photograph 8B which may be scanned, photographed or otherwise rendered as a digital file using any suitable hardware such as a computer, scanner, iPad or tablet 13, smart phones 14 and 15 and/or smart wearable 16.

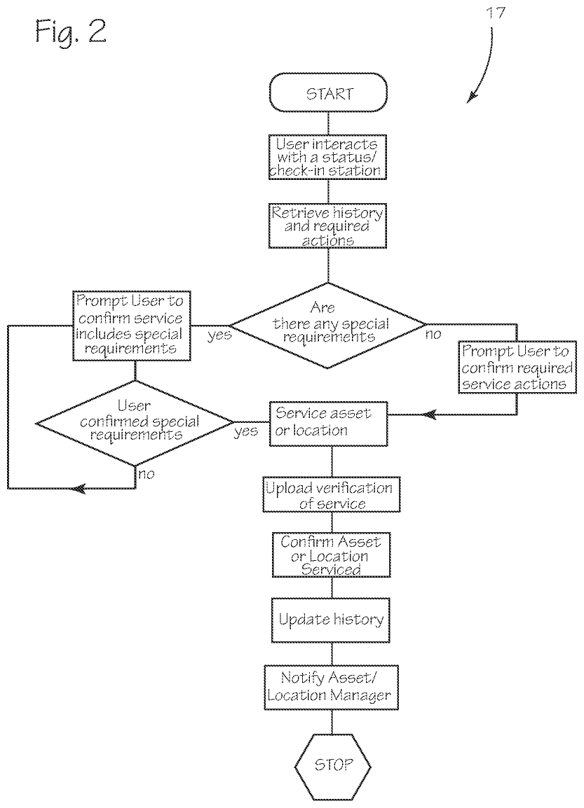

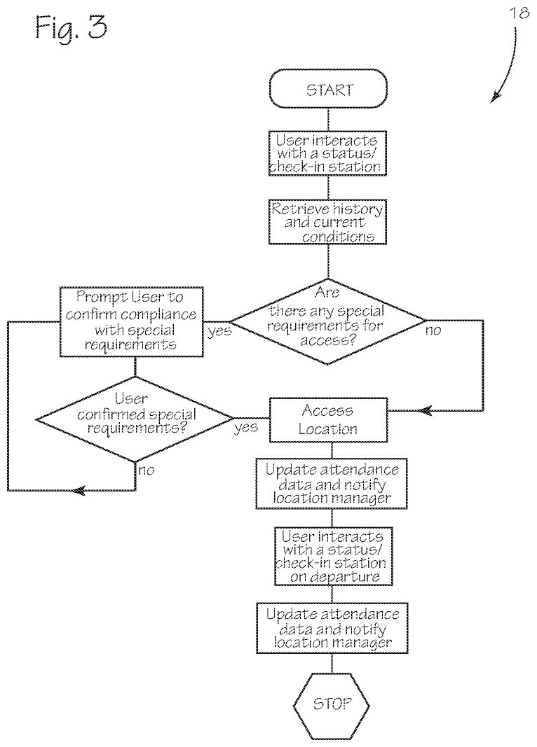

Digital presence information system 1 for location information and access or maintenance control and notification controls access to one or more physical locations such as locations 3A, 3B, 3C or 3D based on documentation 7 received, authenticated and reviewed through status/check-in station 21 in real time for that specific location. The method for obtaining asset information and access is illustrated as method 17 of FIG. 2. The method for obtaining location information and access is illustrated as method 18 of FIG. 3. System 1 ensures that a location owner/manager such as location manager or family member 20 has received the correct user documentation such as licenses, certifications and site specific information before site access is granted. Site manager 20 may use any suitable hardware to access app 4 such as mobile phone 20A or computer 20B.

A status/check-in station 21 can be a simple hardware component or a smart phone or other suitable computing device which communicates with a user's mobile device, such as smart phone 14 at a site access location or at each asset such as locations 3a, 3B, 3C, 3D or assets 9A, 9B or 9C. Interaction with a status/check-in station requires that the mobile device touch, tap or be within any suitable preset distance of the status/check-in station 21 such as touching or at least withing 10 cm. In a preferred configuration, smart phone must be within 2-3 centimeters of status/check-in station 21.

Site access data 24S from status/check-in station 21 coupled with location data 24L identifying the physical site location, triggers an information check to ensure system 1 has the correct documentation or photographs stored to permit a user 11 be allowed on location 3A or that the necessary work, care or maintenance has been performed at a location or on an asset. The system may have different types of status/check-in stations at any different locations or assets.

The system also logs all entry and exit points such as access points 22 and 23, and allow users and location managers to retrieve the actual time on and off locations and the history of location access and how many users are currently accessing a location using any input device.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A method of information management and delivery for an asset comprising the steps:
providing a software application running on a network server and operable to run on a mobile device;
providing a status/check-in station on the asset, the status/check-in station operable to enable a user to use the mobile device to interact with the status/check-in station by bringing the mobile device within a preset distance from the status/check-in station;
the software application providing the user via the network, a service history and one or more lists of asset service requirements from the service history;
the user confirming receipt of the service requirements to an asset manager via the network;
the user performing the necessary service and documenting the service performed using the mobile device and transmitting the service documentation to the asset manager using the software application;
the asset manager using the software application to verify that the service documentation received from the user comply with at least one of the one or more service requirements; and
the software application updating the asset history and notifying the asset manager.

2. The method of claim 1 wherein the preset distance is between 1 and 10 cm.

3. The method of claim 1 wherein the preset distance is between 2 and 3 cm.

4. The method of claim 1 further comprising the steps immediately following the step in which the user interacts with the status/check-in station:
the software application providing the user via the network, one or more special asset service requirements;
the user confirming receipt of the one or more special asset service requirements to an asset manager via the network.

5. The method of claim 4 wherein the step of the asset manager using the software application to verify that the service documentation received from the user comply with at least one of the one or more service requirements further comprises:
the asset manager using the software application to verify that the service documentation received from the user comply with at least one of the one or more special asset service requirements;

6. A method of information management and delivery for location access comprising the steps:
providing a software application running on a network server and operable to run on a mobile device;
providing a status/check-in station at the location, the status/check-in station operable to enable a user to use the mobile device to interact with the status/check-in station by bringing the mobile device within a preset distance from the status/check-in station;
the software application providing the user via the network, one or more lists of location access requirements and location conditions from the location history;
the user confirming receipt of the access requirements and providing to a location manager digital verification of compliance with the access requirements and acknowledgement of the location conditions via the network;
the location manager using the software application to verify that the digital verification received from the user comply with access requirements;
the user accessing the location and the software application updating the location history and notifying the location manager of the location access; and
the user interacting with the status/check-in station upon departure from the location;
the software application updating the location history and notifying the location manager.

7. The method of claim 6 immediately following the step in which the user interacts with the status/check-in station, the method further comprising the steps:
the software application providing the user via the network, a list of special access requirements;
the user confirming receipt of the special access requirements to an location manager via the network.

8. The method of claim 6 wherein the preset distance is between 1 and 10 cm.

9. The method of claim 6 wherein the preset distance is between 2 and 3 cm.
